(19) United States
(12) Patent Application Publication
(10) Pub. No.: US 2011/0321156 A1
(43) Pub. Date: Dec. 29, 2011

(54) Privacy Tool

(76) Inventor: Ned L. Smith, Redmond, WA (US)

(21) Appl. No.: 13/171,301

(22) Filed: Jun. 28, 2011

Related U.S. Application Data
(60) Provisional application No. 61/359,132, filed on Jun. 28, 2010.

(51) Int. Cl. H04L 9/32; G06F 21/00

(52) U.S. Cl. 726/19

(57) ABSTRACT

The present invention provides a method and system for hiding private activities on logged on computing devices of all types. Its countermeasures help users inconspicuously block snoops manually or automatically by moving from sub-profiles displaying sensitive data to sub-profiles displaying non-sensitive data, or even no data at all.

Instead of using only currently standard single-profile within a single user account, the invention offers a mechanism to use multiple sub-profiles within a single user account. In addition, the invention offers the ability for users to inconspicuously switch between these sub-profiles while staying logged into sub-profiles' single user account. This is accomplished by giving the user inconspicuous interfaces for entering different sub-passwords.

### RELATED APPLICATIONS

This application claims priority to Application No. 61359132, filed 28 Jun. 2010, entitled “Privacy Tools”, which is hereby incorporated by reference.

### BACKGROUND OF THE INVENTION

Users of computing devices of all types today are frequently in gray area security situations wherein the user wants to leave their logged on system open for others to view, but at the same time they want to avoid the risk of exposing sensitive data contained therein.

Social stress and suspicion result if a user conspicuously locks a system or closes applications whenever family, friends, co-workers, rivals, competitors, bosses, suspected stalkers, etc., approach.

Additionally, co-workers, bosses, contractors, customers, etc., routinely need to view data on a user's application and operating system device. But the owner of the device and that owner's organization are at risk if the user or guest accidentally or intentionally navigates the user interface to sensitive corporate or private information.

Additionally, hand held devices have become status symbols and fashion statements. Users want to show off their devices. Or, sometimes curious acquaintances suddenly pick up a device and start navigating around its user interface to check it out. This often results in accidentally or intentionally coming across a salacious text, an angry text from a spouse, a sensitive corporate communication, or proprietary application data such as drawings, diagrams, plans, inventions, or other sensitive items.

Computing devices today have multiple unique profiles. However, within these single profiles there is no mechanism to separate and merge incoming and outgoing message data according to unique sub-profile driven contexts. Therefore, a user cannot automatically keep his work and private communications securely separate within a single email, instant message, text messages, device's operating system account, etc.

Additionally, in the case of stalker victims, application and operating systems don't shield a device, and therefore its user, from stalkers' frequent calls, emails, texts, instant messages, etc., and they don't quietly gather security records of each event.

Considering the foregoing concerns, there is a need in the art for application and operating system countermeasures that hide sensitive data from the view of snoops without requiring the user to log off the application or operating system.

### SUMMARY

In view of the foregoing needs, the present invention provides a method and system for hiding private activities on logged on computing devices of all types. Its countermeasures help users inconspicuously block snoops manually or automatically by moving from sub-profiles displaying sensitive data to sub-profiles displaying non-sensitive data, or even no data at all.

Instead of using only currently standard single-profile within a single user account, the invention offers a mechanism to use multiple sub-profiles within a single user account. In addition, the invention offers the ability for users to inconspicuously switch between these sub-profiles while staying logged into sub-profiles' single user account. This is accomplished by giving the user inconspicuous interfaces for entering different sub-passwords.

In one embodiment, a user could enter different sub-password to switch between sub-profiles appropriate to various social environments. One sub-profile may be appropriate to the home environment, another to the work environment, another for personal use, and so forth for as many sub-profiles as the user requires. Each sub-profile reveals only the data appropriate for its designated environment.

Further, the invention could be configured to overcome user errors that cause data to stray out of designated sub-profiles to comingle in inappropriate sub-profiles. For example, the record of an instant message sent from the home sub-profile to a work contact would never show up in the sent instant messages of the home sub-profile. Instead, the record would only be viewable from the work sub-profile's instant message records. Similarly, incoming replies to this message sent from the wrong sub-profile, would be addressed to and stored in the work sub-profile. Thus the invention could compensate for user errors.

By the use of this invention, the user can define precisely how interactions will take place. For instance, work calls could be configured to not ring while in the home, personal, or other non-work sub-profiles. Or combinations could be allowed, such as work and home sub-profile calls being allowed to ring while in the home sub-profile, but personal calls could be configured to not ring those sub-profiles.

In one embodiment, sub-profile passwords could be entered inconspicuously in an operating system or application search bar. For instance, you could enter the sub-password as if it were a search string to reveal messages, addresses, or phone numbers. In such an example, an email user could switch from her home sub-profile to her work sub-profile by entering a password in any interface, even when she is just in the reading mode. Upon entering her work sub-profile password, she would gain access to the information associated with the work sub-profile. This eliminates the steps of having to log off her non-work email account which sets off the time consuming multiple steps of closing her email application entirely, then having to logon with a different user account and password, then having to wait for her email application to reload.

In yet another embodiment, using the previous patents referenced above, the user could switch quickly from one privacy sub-profile to another using a fast key-stroke combination.

In yet another embodiment, using the previous patents referenced above, the user could use motion detection to trigger sub-profile switching.

In another embodiment, using the previous patents referenced above, the invention could use an idle time threshold to trigger sub-profile switching.

In a combination of the above embodiments that trigger sub-profile switching with key-strokes, motion detection, and fast-keys, the invention could additionally lock the screen over the top of these sub-profile changes, as referenced in the patents referenced above. For example, a user returns with a co-worker to her cubicle to discuss a document. When they arrive, the sub-profile has switched to an empty desktop, creating the impression no applications are open. In addition it could lock the screen with a logon prompt. The user logs on in the presence of the co-worker. No private programs or information are visible, just a standard desktop or home screen. The user can now open the document that the guest is interested in.

In another embodiment, the invention automatically or manually moves a handheld device to a blank sub-profile, or a blank sub-profile with the logon prompt. This prevents an uncomfortable situation mentioned previously, wherein an acquaintance enthusiastically grabs a user's handheld device. Let's say the user device is a phone. The acquaintance starts checking out its interface and features. Be she accidentally stumbles into the text messages or some other private area on the device and finds a sensitive document, like a personal text. If the invention were running on the system, it could be configured to have already automatically moved to a blank sub-profile. Then the acquaintance would only find public information, or alternatively, no messages in the text or email queues, no phone numbers in the address book, no documents in the applications, etc.

In one embodiment the invention could be used as a honeypot. It could accept any password to grant a very restrictive level of access. This increases security by making hackers believe they have accessed a secure application or OS. When they find no data they presume it's useless to them and stop searching it.

In another embodiment, the computing or communications device could secure itself by purging items after a certain number of failed login attempts. In one iteration, it could self-purge sub-profile data after, say, three failed logon attempts. In another it could purge the actual sub-profiles and their data.

The wake of the Tiger Woods scandal further showed the need for such an invention. Other applications, such as Tiger Text, attempt to solve the problems stated above but they fall short of securing data since it only deletes messages after a period of time. There exists a need for a better way to keep private communications from being revealed beyond your private circle.

### DESCRIPTION OF THE DRAWINGS

FIG. 1 illustrates one example of a user interface for displaying contact information.

FIG. 2 illustrates one example of a user interface for receiving sub-password information.

FIG. 3 shows one embodiment of a data structure that can be used with respect to the present invention.

FIGS. 4A-4C illustrate one example of how the present invention can be used at the application layer.

FIG. 5 illustrates one example of how the present invention can be used at the operating system layer.

FIGS. 6A-6B are flow diagrams of one embodiment of the present invention.

### DETAILED DESCRIPTION

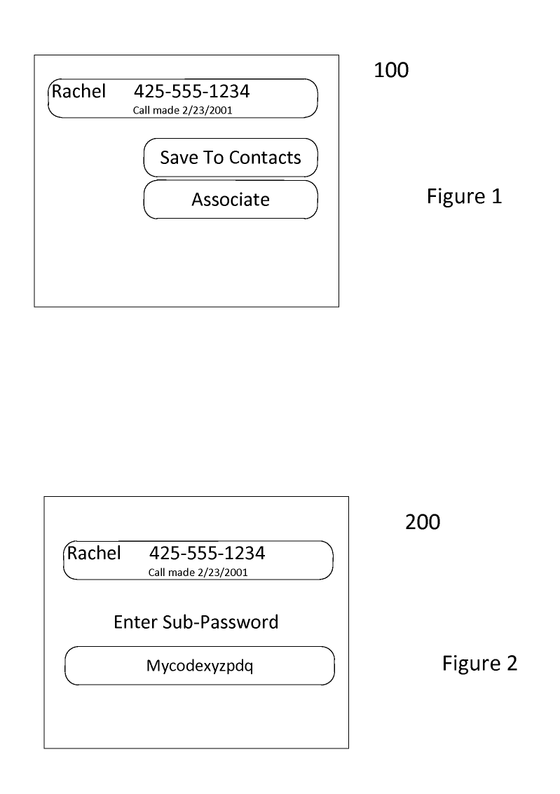

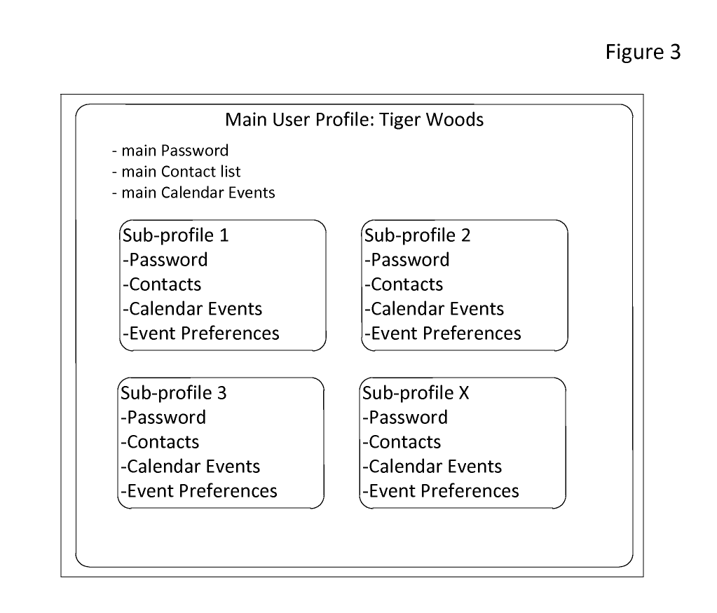

FIG. 1 shows one example of how the present invention can be used on a device. In this example, it is given that a user is logged into the device using a user profile and an associated password. In this example, a user interface 100 shows some contact information, which in this case is a phone number. Like any other general application, this contact information may be displayed in response to a phone call, text message, contact list edit, email, etc. The user interface 100 provides a mechanism to associate a sub-password with the contact information. Here, in this example, the user interface 100 provides a button “Associate” that allows the user to enter a sub-password that should be associated with the contact information. Once the user presses the button, as shown in FIG. 2, the user interface 200 allows for an entry of the sub-password. As known, there are many other ways the device can receive the sub-password without the use of an “associate” button. For instance, a sub-password entry field can be displayed with the contact information, etc. In other embodiments, the password may not require a user prompt. In such an embodiment, the user can just enter a password while simply viewing the contact information, and then another interface can be displayed to allow the user to verify the association.

Once the password is received in the “Enter Sub-Password” field, the device makes an association between the sub-password and the contact information, which in this case is a phone number. In this example, the entered sub-password is “mycodexyzpdq,” and the mechanics of the present invention associate this sub-password and to the contact information shown on the user interface 100. From that point, depending on the settings of the sub-profile, mechanisms in the device prevent applications and operating system interfaces from displaying the contact information without the sub-password. In one example, the settings of the sub-profile can instruct the device not to display a message or invoke alerts when a text message is received from a particular person. Such text messages will be hidden from the user until the sub-password is provided.

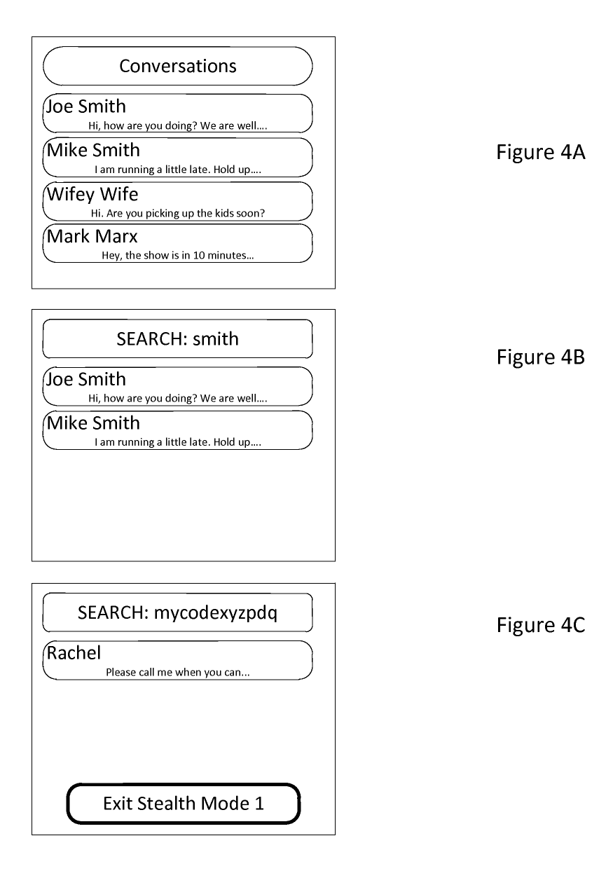

FIG. 3 shows one embodiment of a data structure that can be used with the present invention. In this example, a main user profile can be setup with sub-profiles, where the main user profile and each of the sub-profiles have associated passwords, contact items, calendar items, etc. This data structure will enable the user, in this case Tiger, to have all of the common functions of a user profile. It will include a password and all of the associated user settings. In addition, the data structure also contains an extensible list of sub-profiles. In this example, each sub-profile has a password and other data items, such as contacts, phone numbers, calendar events, and event preferences.

The device uses the sub-profile information to allow the user to control the display or access of any of the data associated with a particular sub-profile. For example, Tiger Woods can setup a sub-profile so that all calls and texts from Rachel remain silent and are not recorded in the call list or text log until the sub-password is received. In Tiger Woods' most recent situation, he would have preferred to have all of Rachel's text and calls to be hidden until he desired access. This is also better than the Tiger Text application because he can still keep the records but only see them when desired. Tiger Text simply deletes messages after a period of time. Here, they are hidden until desired.

The configuration of FIG. 3 is only one way of constructing the concepts of the present invention. Sub-profiles are not absolutely needed. It can be done in a number of different ways. For instance, a device configured with the present invention can simply have associations between a special keyword (a password of some kind) and a single piece of contact information, such as a phone number. The sub-password may or may not be stored in any safe location and can be encrypted. The sub-password can also be hidden in parts of memory that aren't accessible by standard applications.

Now moving to the application layer, here are some examples of how the sub-password can be used to selectively show the hidden information. In some embodiments of the present invention, it is desirable to have a sub-password entry mechanism that does not conspicuously show an entry field. For example, programs or the operating system can receive a password without showing any prompt for a password. In one example, a password can be received in a generic search field of an application, such as a contact, calendar or text application. In addition, the alternative passwords can be received at the prompt for a main password. So in this example, unlike other programs or operating systems, one password field can receive different password (in this case sub-passwords) and take different actions based on the received password and the user's preferences.

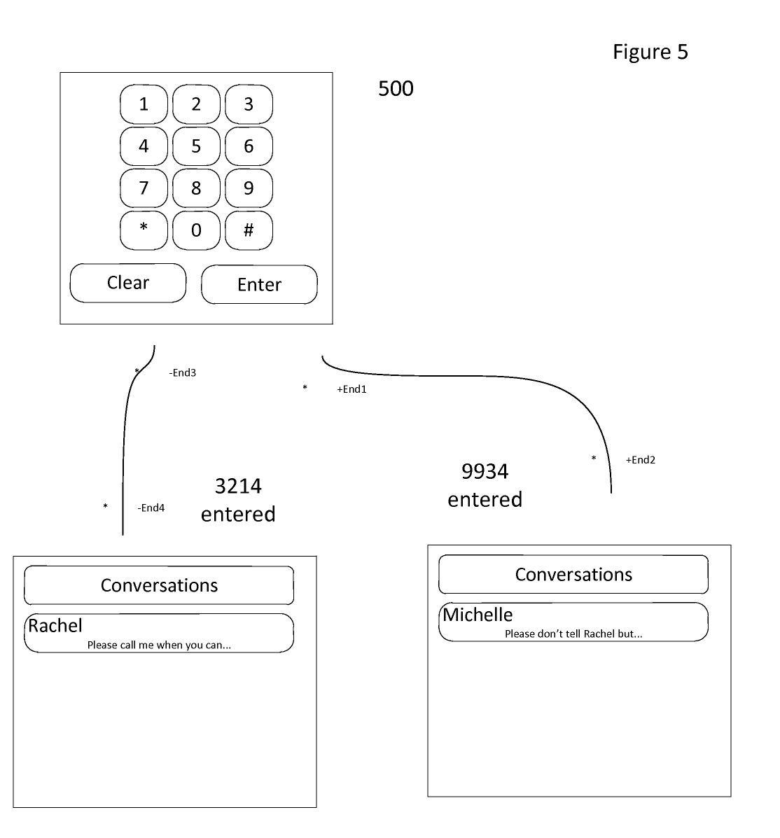

FIGS. 4a-4c show one example in how this concept can be implemented at the application layer. FIG. 4a shows the interface of a typical texting program. In this example, the program shows the status of the application and multiple conversations associated with a particular user.

As shown in FIG. 4b, the interface automatically changes as the user types in a string “smith”. Notice that there wasn't a prompt for the password, instead the user just starts typing when viewing texts. In some applications, this is a way searches are handled. As with any typical search feature, individual conversations appear as the program filters for the entered string. Here, when the user types in “smith,” the application filters all of the conversations and simply shows all of the conversations that have “smith” in them. Here, in FIG. 4B, the application only shows conversations from Joe Smith and Mike Smith.

However, if the user types in the pre-configured keyword or sub-password, “mycodexyzpdq”, as shown in FIG. 4C, all conversations associated with Rachel are unlocked and automatically displayed in the conversation section of the text program. With the features of the present invention, the text conversation and phone calls associated with Rachel are not displayed or even discoverable in a search until the sub-password is entered. When the sub-password is received, the application goes into a mode where specific text conversations are displayed, such as the conversation of Rachel. In this example, the application shows the special mode by displaying some indication of the mode, which also provides a button for the user to exit the special mode. The device can exit the special mode in a number of different ways. For instance, it may timeout after a set period, it may exit the special mode when the screen locks, etc.

In one aspect of the present invention, the sub-password is received in any window that does not normally receive text. For instance, in most mail programs today, when you start to type keys while looking at your in-box, the mail program doesn't take any action. However, when configured with the present invention, that viewing window, which normally doesn't provide any interaction when keys are pressed. So basically, the sub-password or the main password can be typed into any text entry field, it can even be typed into user interfaces that don't visually display text or data-entry symbols (such as the password dots) when the password or sub-password is entered. Traditional fields, such as a login prompt, a non-password prompt, or any other field for receiving text can be used as well. The present invention can benefit from any combination of these password entry scenarios.

The same feature described can be used in other applications and various levels of an operating system. For instance, in an application that manages contacts, when the user searches for a contact, special contacts are exclusively displayed on the screen when a special keyword or sub-password is entered. In radio-based communication, phone calls can be all directed to a special call log. Voicemails from certain phone numbers can only be displayed and played when the sub-password is entered. Similarly, the device can be set so that phone calls to and from those special contacts, like Rachel, can only be made and received when the device is in the special mode. If the user does make a call from the standard profile, say to Rachael, then all of the call information is hidden in the sub-profile.

It is preferred to not display the sub-password in any embodiment of the present invention. As mentioned above, it is also beneficial to not design a password prompt specifically for sub-passwords. That is part of the feature's stealthiness: No one knows that a sub-password is there.

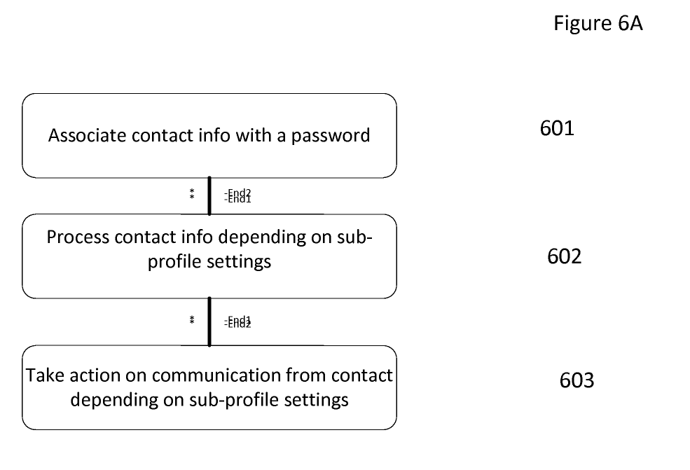

FIG. 5 shows one example of how the present invention can be used at the operating system layer. Much like a typical configuration of today's technology, a mobile phone screen shows a keypad for a password entry. When the user enters the right password, the system unlocks. That is great. But systems generally do not allow one keypad to grant access to multiple profiles or sub-profiles. Here, a sub-password can be entered, and the phone can enter a special mode. In the above example, let's say that Tiger Woods used the sub-password “3214” instead of “mycodexyzpdq.” When the screen is locked, Tiger can get right to Rachel's texts and phone call logs by entering the sub-password at the operating system level. Here, in this screen, instead of entering his normal password, he enters “3214”. When that sub-password is entered, the phone goes into an operational mode, but it only shows contacts, texts, emails and phone calls related to Rachel. If he enters another sub-password “9934” the phone goes into another operational mode only where other communications and information from other contacts, such as your “work” contacts, are displayed.

The same can be done at the operating system level with a password-protected screen saver. When a password is entered at a screen saver, the computer can enter one of a number of modes depending on the password the user enters. If the user enters their main password, the device enters the window state that they were in when the screen saver was activated. If they enter a special sub-password, the computer can enter a clean mode where windows of business applications appear, instead of showing windows the user was viewing when the screen saver was activated.

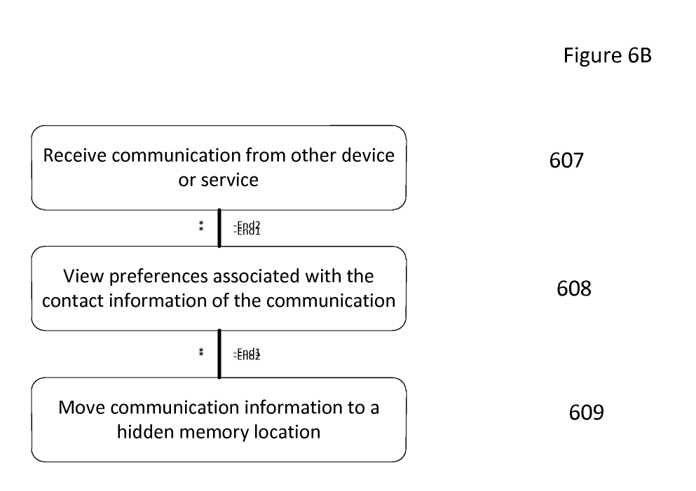

FIG. 6A shows a flow diagram of a method for managing contact information and communications for the invention. In step 601, the device associates a sub-password with some contact information. The contact information may be an email address, phone number, or any other identifying information. After the sub-password is associated with the contact information, at step 602, the device takes some action dependent on the device settings. The device may be setup to hide all communications associated with the contact information. In other embodiments, the device and a user profile or sub-profile preference setting may instruct the device to just hide text messages. At step 603, which can be done with or without step 602, the device takes action on the contact information. For example, received phone calls associated with the contact information may allow a phone to ring, but it will show it as a blank name and blank number, or it could say “spam”. Whatever the setting, the device can be configured to take any action on that number. One desired action is to make sure the phone does nothing when that person calls or texts. It only issues an alert or ring when the user is in the special mode using the sub-password. In addition, the call log or text message information is moved to a hidden location in the device's memory.

The above actions of step 603 are shown in FIG. 6B. At step 607, the device receives the communication, such as a phone call or a text message. At step 608, the preferences of the device are evaluated to determine the action that should be taken depending on the contact information. In the above example, Rachel's phone number would be associated with a hidden status, and the phone would not ring, and the text messages would be hidden and the text would not cause the device to ring or vibrate. The device can also be configured to manage anonymous calls in the same way. Each communication from an anonymous contact would be hidden and the contact would not cause the device to ring or vibrate. At step 609, which can be done before or after step 608, the device moves the call data to a secured section of memory. The secured section of memory can be made with a data structure, as the one described above, or any other configuration that hides the data until the right sub-password is entered. In a separate process, the user can view the hidden information by typing in the sub-password. Then the information is hidden again after the user locks the phone, or takes some other like action that is invoke by a screen saver.

The above examples allow users to loan their phone for a short period of time without the worry of people receiving personal text messages, emails, phone calls, etc. Tiger Woods would have been in a much better situation if he would have had these features.

There are a number of ways of developing the concepts of the present invention. For instance, the sub-profiles and sub-passwords can be received and managed at the application layer, at the operating system layer or a combination of the two layers. In some of the above examples, the sub-password and sub-profile information can be entered at any layer of the device or in any application. Specific to the example of the entry of the sub-password, prompts for the sub-password can be made in a contact program, a text program, email program, instant message program, etc.

This program has many applications other than hiding information. For instance, to avoid telemarketers, a person can associate any unwanted calls with a particular password, such as a password “spam.” That way, the user can avoid hearing the calls and texts. But this is better than a standard blocking mechanism in that the user can go into a special mode to see when the spam calls were made. Users don't hear or see the unwanted calls until they want to. There is no other phone out there that manages unwanted calls or texts in this way. A user can have his or her phone remain quiet, unless they really want to see the unwanted traffic. This may be even more desirable in criminal situations where a victim would want to avoid calls from an assailant but have access to them to show authorities for help if that is desired.

In one embodiment, the invention includes a security system. The security system includes some code, or an object set for displaying a screen saver on a user interface. The screen saver has a password prompt. The security system also includes a data structure storing a first password and a second password, both passwords being associated with one user profile. The security system also includes code or an object set for displaying an alternative window set when the second password is entered in the prompt. For example, if Tiger were to enter a pre-set password “Emergency” in his computer, it would display only spreadsheet applications. If Tiger were to enter the first password, or in other words the main password, the computer would simply unlock his computer and display a standard window set, or in other words, the windows he was viewing when the screen saver was activated.

In another implementation of the present invention, a mobile device can be configured to allow for seamless transfer between profiles. A phone can be configured with a generic profile, so when someone wants to use your phone, you can tell them the password and that password would only give access to a special set of services, like the phone and calendar. The generic profile password is different than the user password, which gives full rights to all applications and personal information. With this feature, you could even give your generic profile password to a coworker, and they would never inadvertently run into your personal messages or calls. The state transfer can transition from a standard user screen, such as an application list, to a screen lock with a password entry keypad, and then with the entry of a generic profile password, the device transfers to a limited state that only allows for particular information and applications. This features helps in scenarios where a coworker wants to use you phone. Once a person asks to use your phone, you can inconspicuously lock the screen, and then type in the generic profile password just before you hand the phone to that person. There will be no issues of them running into your personal messages, or even looking up your browsing history, etc.

In view of the foregoing description, I claim my beloved ideas as follows:

1. A security method for providing secured access within a user profile, the user profile having a main password, and a second password, in a state of the device where a user is logged in using the main password, the method including:
Displaying a user interface with one item of contact information, the user interface allowing for entry of the second password, the password being associated with the contact information;
Changing the display status of the contact information in all displays while the user is logged in using the main password, the changed status limiting the view of records associated with the contact information; and
Activating a second mode when the second password is entered in the device, wherein the second mode allows for the display of communication associated with the contact information.

2. The method of claim 1, wherein the records include text messages, emails, and calls.

3. A security system, where the system includes:
An object set for displaying a screen saver on a user interface, the screen saver having a password prompt;
A data structure storing a first password and a second password, both passwords being associated with one user profile;
A object set for displaying an alternative window set when the second password is entered in the prompt, and alternatively displaying a standard window set when the first password is entered in the prompt.

4. A security system, where the system includes:
A data structure for allowing the entry of a password without providing a prompt for the password.

5. the system of claim 4, wherein the entry of the password is done in a user interface that displays messages.
